(19) United States
(12) Patent Application Publication
(10) Pub. No.: US 2025/0361443 A1
(43) Pub. Date: Nov. 27, 2025

(54) SOIL MODIFIER, CULTURE SOIL, AND METHOD FOR PRODUCING SOIL MODIFIER

(71) Applicant: Murata Manufacturing Co., Ltd., Nagaokakyo-shi (JP)

(72) Inventors: Yuuta HOSHINO, Nagaokakyo-shi (JP); Tomoya OOSHIMA, Nagaokakyo-shi (JP); Mitsuru NAKANO, Nagaokakyo-shi (JP); Daisho TSUBOKAWA, Nagaokakyo-shi (JP)

(21) Appl. No.: 19/293,054

(22) Filed: Aug. 7, 2025

Related U.S. Application Data
(63) Continuation of application No. PCT/JP2023/036271, filed on Oct. 4, 2023.

(30) Foreign Application Priority Data
Feb. 14, 2023 (JP) 2023-020747
May 26, 2023 (JP) 2023-087047

(51) Int. Cl. C09K 17/04; A01G 24/12; A01G 24/42

(52) U.S. Cl. CPC C09K 17/04; A01G 24/12; A01G 24/42

(57) ABSTRACT

A soil modifier that includes: base particles that are particles of SiO₂ having a particle size of 100 nm or more, and the central particle size of the base particles is 120 nm to 800 nm in a particle size distribution of the SiO₂ particles. A culture soil includes soil and the base particles.

### CROSS REFERENCE TO RELATED APPLICATIONS

The present application is a continuation of International application No. PCT/JP2023/036271, filed Oct. 4, 2023, which claims priority to Japanese Patent Application No. 2023-020747, filed Feb. 14, 2023, and Japanese Patent Application No. 2023-087047, filed May 26, 2023, the entire contents of each of which are incorporated herein by reference.

### TECHNICAL FIELD

The present disclosure relates to a soil modifier, culture soil, and a method for producing the soil modifier.

### BACKGROUND ART

Patent Literature 1 discloses a silicic acid absorption promoting agent that promotes absorption of silicic acid by a gramineous plant. The silicic acid absorption promoting agent described in Patent Literature 1 is an aqueous solution containing one or more types of sugars and an organic acid as an additive having an effect of enhancing the absorption effect of soluble silicic acid.
Patent Document 1: Japanese Patent Application Laid-Open No. 2017-214368

### SUMMARY OF THE DISCLOSURE

The silicic acid absorption promoting agent as described in Patent Document 1 promotes the absorption of silicic acid for plants having a large amount of absorbed silicic acid such as grasses. Therefore, when a silicic acid absorption promoting agent is administered to a plant that is difficult to absorb silicic acid, the effect is difficult to be obtained.

In order to solve the above problems, one aspect of the present disclosure is a soil modifier including SiO₂ particles, in which a central particle size of the SiO₂ particles having a particle size of 100 nm or more is 120 nm to 800 nm in a particle size distribution of the SiO₂ particles.

In addition, one aspect of the present disclosure is a culture soil including: soil; and SiO₂ particles, in which a central particle size of the SiO₂ particles having a particle size of 100 nm or more is 120 nm to 800 nm in a particle size distribution of the SiO₂ particles.

Further, an aspect of the present disclosure is a method for producing a soil modifier, the method including: charging an object to be coated with a glass film into a reaction container; charging a metal alkoxide or a metal alkoxide precursor into the reaction container; charging a catalyst for accelerating hydrolysis of the metal alkoxide into the reaction container; forming a glass film on a surface of the object by hydrolyzing, and dehydrating and condensing the metal alkoxide; recovering the solution in the reaction container after the forming of the glass film; and drying sol-like or gel-like SiO₂ particles included in the solution, in which after the drying, the a central particle size of the SiO₂ particles having a particle size of 100 nm or more is 120 nm to 800 nm in a particle size distribution of the SiO₂ particles.

The growth of plants can be promoted regardless of the ability of plants to absorb silicic acid.

### BRIEF EXPLANATION OF THE DRAWINGS

FIG. 1 is an image obtained by imaging SiO₂ particles.

FIG. 2 is an image obtained by imaging SiO₂ particles.

FIG. 3 is a schematic sectional view of SiO₂ particles.

FIG. 4 is a view showing results of Comparative Test 1 and Comparative Test 2.

FIG. 5 is a view illustrating a result of Comparative Test 3.

FIG. 6 is an explanatory view for explaining a method for producing a soil modifier.

FIG. 7 is an explanatory view for explaining a method for producing a soil modifier.

FIG. 8 is an explanatory view for explaining a method for producing a soil modifier.

FIG. 9 is an explanatory view for explaining a method for producing a soil modifier.

FIG. 10 is an explanatory view for explaining a method for producing a soil modifier.

FIG. 11 is an explanatory view for explaining a method for producing a soil modifier.

FIG. 12 is an explanatory view for explaining a method for producing a soil modifier.

### DESCRIPTION OF THE PREFERRED EMBODIMENTS

### First Embodiment

Hereinafter, a first embodiment of a soil modifier, a culture soil, and a method for producing a soil modifier will be described.

### (Soil Modifier and Culture Soil)

The soil modifier is a collection of substantially spherical SiO₂ particles. Specifically, the soil modifier includes SiO₂ particles in a weight ratio of 99% or more. SiO₂ may be referred to as silica or the like. In addition, the “SiO₂ particles” mean particles containing SiO₂ as a main component. The soil modifier further includes one or more elements or compounds selected from Na, Cl, P₂O₅, and SO₃. Specifically, the soil modifier includes Na in a weight ratio of 6 ppm. In addition, the soil modifier includes Cl in a weight ratio of 0.02%, P₂O₅ in a weight ratio of 0.01%, and SO₃ in a weight ratio of 0.04%.

The coefficient of variation of SiO₂ particles included in the soil modifier is 0.30 or less. The coefficient of variation is a value obtained by dividing the standard deviation of the particle size of SiO₂ contained in the soil modifier by the average value of the particle size of SiO₂.

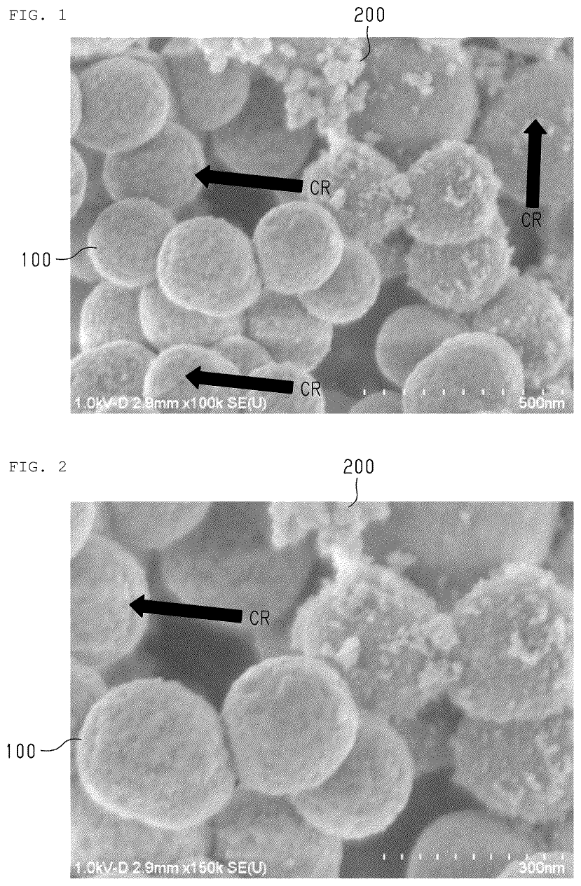

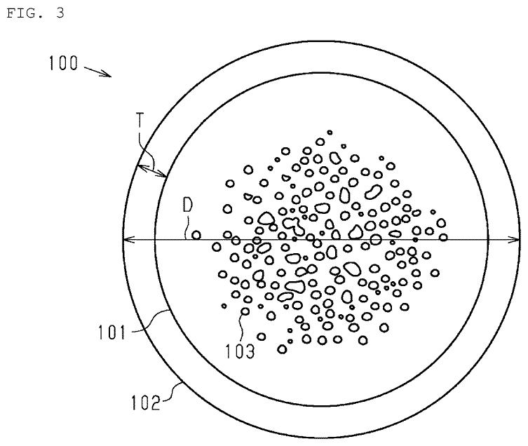

As illustrated in FIGS. 1 and 2, the soil modifier includes base particles 100 and fine particles 200. The “base particles” are SiO₂ particles having a particle size of 100 nm or more among SiO₂ particles. In addition, the “fine particles” are SiO₂ particles having a particle size of less than 100 nm among SiO₂ particles. In addition, in the first embodiment, when referring to the entire particles including both base particles 100 and fine particles 200, they are simply described as “SiO₂ particles”. The image illustrated in FIG. 1 is obtained by imaging SiO₂ particles at 100,000 fold magnification with a scanning electron microscope (SEM). The image shown in FIG. 2 is obtained by imaging SiO₂ particles at a magnification of 150,000 fold by SEM. In addition, the imaging range in FIG. 2 and the imaging range in FIG. 1 overlap with each other.

A plurality of fine particles 200 are attached to the outer surface of base particles 100. “adhering” means that, for example, when SiO₂ particles are washed with a liquid, the particles are integrated with each other to such an extent that fine particles 200 do not fall off from base particles 100. Specifically, a chemical bond such as a covalent bond exists between fine particles 200 and base particles 100. In addition, a part of base particles 100 has cracks CR. The “crack” is a generic term for linear images on the surface of base particles 100 observed when imaged under the above conditions. That is, the crack CR is a groove-shaped recess, a linear flaw, a step, or the like generated on the surface of base particles 100.

The central particle size of base particles 100 is 120 nm to 800 nm in the particle size distribution of base particles 100. In addition, the central particle size of fine particles 200 is 10 nm or more and less than 100 nm in the particle size distribution of fine particles 200. The “central particle size” is a median value of particle sizes in a particle size distribution. That is, the “central particle size” is a so-called median size (D50).

In the soil modifier, the specific surface area of the SiO₂ particles is 15 m²/g to 200 m²/g. For example, in the first embodiment, the specific surface area of the SiO₂ particles is 163 m²/g. The specific surface area is a surface area value per unit weight. The specific surface area of the SiO₂ particles is measured using, for example, a gas adsorption measurement method (BET method) using the BET equation. The BET method is a method for measuring the surface area of particles by adsorbing a gas having a known adsorption occupancy area on the surfaces of the particles.

In the soil modifier, the SiO₂ particles include carbon in a weight ratio of 1.5% to 5.0%. For example, in the first embodiment, the SiO₂ particles include carbon in a weight ratio of 1.5%. The weight ratio of carbon included in the SiO₂ particles can be measured using a carbon/sulfur analyzer (CS meter). In the carbon measurement by the CS meter, SiO₂ particles are dissolved in a high-frequency heating furnace in an oxygen stream. In this case, the carbon component included in the SiO₂ particles is converted into CO, CO₂, and the like. Then, the amount of the carbon-derived gas is measured by an infrared detector. As a result, carbon included in the SiO₂ particles is quantified. From the quantitative result of carbon, the weight ratio of carbon included in the SiO₂ particles is calculated.

As shown in FIG. 3, the base particles 100 have voids 103 therein. Although not illustrated, fine particles 200 also have voids 103 therein. In a sectional view of one particle of SiO₂, the ratio of the area of the region occupied by voids 103 to the sectional area of the one particle is defined as the porosity of the single particle. The porosity of the single particle is 0.2% to 6.0%. More specifically, in the first embodiment, the porosity of the single particle is 0.2% to 2.0%. For example, the porosity of a single particle is 1.2%. The porosity can also be measured by, for example, image analysis of an image captured by a transmission electron microscope.

The culture soil includes soil and the above-described soil modifier. That is, the soil includes SiO₂ particles. The soil itself has a pH of 6.5±0.5 and an electrical conductivity of 1.0 mS/cm. The SiO₂ particles are included in an amount of 0.2 g to 1.5 g based on 1 liter of the soil. In addition, a part of SiO₂ particles is dissolved in water in the soil to become silicic acid.

The SiO₂ particles are preferably included in an amount of 0.2 g to 0.4 g based on 1 liter of the soil. As an example, about 0.27 g of SiO₂ particles is added per 1 L of the soil. In this example, when the SiO₂ particles are dissolved in water, the concentration of silicic acid in the culture soil is estimated to increase by about 21 ppm as compared with that before the SiO₂ particles are dissolved. Silicic acid refers to a compound that is water-soluble and includes SiOH, such as orthosilicic acid (H₄SiO₄) and metasilicic acid (H₂SiO₃). In addition, in the soil, silicic acid may be present as a silicate such as calcium silicate (Ca₂SiO₄).

The voltage by the microbial power generation using the culture soil is 0.7 V or more. The voltage generated by microbial power generation can be measured as follows. That is, the culture soil was charged into a measuring instrument (microbial fuel cell experiment instrument, part number: MudWatt, manufactured by KENIS LIMITED). Then, the voltage generated between the electrodes of the microbial power generation measuring instrument was measured two weeks after the charge.

### (Results of Comparative Test 1)

Comparative Test 1 was performed on the culture soil described in the first embodiment. In Comparative Test 1, radishes were cultivated for one month under four different conditions. Using the sample group under each condition as Example 1, Example 2, Comparative Example 1, and Comparative Example 2, the average weight of the edible portions of the radishes after cultivation was determined. In this test, the edible portion of the radishes refers to the portions of leaves, roots, and roots.

Example 1 is radishes cultivated by using the culture soil described in the first embodiment and by spraying pure water. That is, the culture soil used for the cultivation of Example 1 includes about 0.27 g of SiO₂ particles per 1 L of the soil. Radishes were seeded on the culture soil. Then, immediately after the radishes were seeded, about 21 mL of pure water per 1 L of the culture soil was sprayed every day except for rainy conditions.

Example 2 is radishes cultivated using the culture soil described in the first embodiment and by spraying a 1% sodium chloride solution. The cultivation conditions of Example 2 are the same as those of Example 1 except for the type of spray water. Thus, the culture soil used for the cultivation of Example 2 includes about 0.27 g of SiO₂ particles per 1 L of the soil. The radishes were seeded on the culture soil, and immediately thereafter, about 20 mL of a 1% sodium chloride solution per 1 L of the culture soil was sprayed every day except for rainy conditions.

Comparative Example 1 is radishes cultivated by using the soil described in the first embodiment and by spraying pure water. That is, the soil used in the cultivation of Comparative Example 1 does not include the above-described soil modifier. The cultivation conditions of Comparative Example 1 are the same as those of Example 1 except that the soil does not include a soil modifier. Radishes were seeded on this soil, and immediately thereafter, about 20 mL of pure water per 1 L of culture soil was sprayed every day except for rainy conditions.

Comparative Example 2 is radishes cultivated using the soil described in the first embodiment and by spraying a 1% sodium chloride solution. That is, the soil used in the cultivation of Comparative Example 2 does not include the above-described soil modifier. The cultivation conditions of Comparative Example 2 are the same as those of Example 2 except that the soil does not include a soil modifier. That is, radishes were seeded in this soil, and immediately thereafter, at regular intervals, about 20 mL of a 1% sodium chloride solution per 1 L of the culture soil was sprayed.

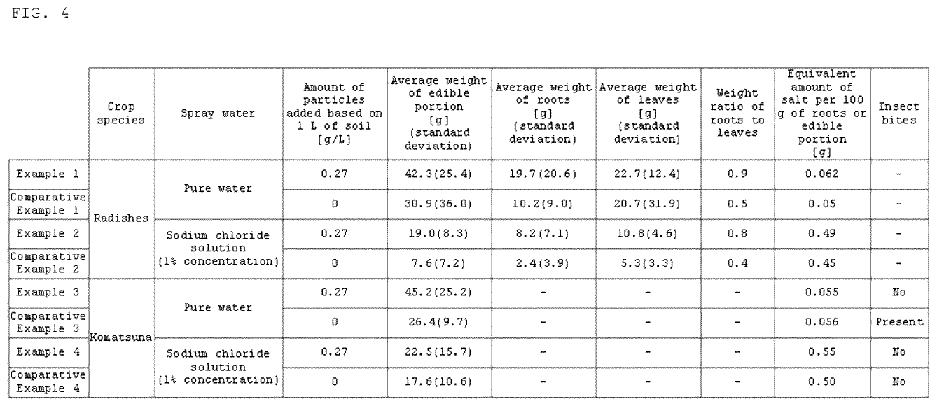

As shown in FIG. 4, the average weight of the roots of Example 1 was about 19.7 g and the average weight of the leaves was about 22.7 g. Therefore, the average weight of the edible portion of Example 1 was about 42.3 g. In addition, the ratio of the weight of the roots to the weight of the leaves for Example 1 was about 0.9. In contrast, the average weight of the roots of Comparative Example 1 was about 10.2 g, and the average weight of the leaves was about 20.7 g. Therefore, the average weight of the edible portion of Comparative Example 1 was about 30.9 g. In addition, the ratio of the weight of the roots to the weight of the leaves for Comparative Example 1 was about 0.5.

In Example 1, the concentration of silicon included per 50 g of radish roots was 10 ppm. In contrast, in Comparative Example 1, the concentration of silicon included per 50 g of radish roots was 24 ppm. From these results, it has been found that including the SiO₂ particles in the soil allows growth to be promoted regardless of the capacity of plants for silicic acid absorption.

In addition, the average weight of the roots of Example 2 was about 8.2 g, and the average weight of the leaves was about 10.8 g. Therefore, the average weight of the edible portion of Example 2 was about 19.0 g. In addition, the ratio of the weight of the roots to the weight of the leaves for Example 2 was about 0.8. In contrast, the average weight of the roots of Comparative Example 2 was about 2.4 g, and the average weight of the leaves was about 5.3 g. Therefore, the average weight of the edible portion of Comparative Example 2 was about 7.6 g. In addition, the ratio of the weight of the roots to the weight of the leaves for Comparative Example 2 was about 0.4. From the results of Example 2 and Comparative Example 2, it has been found that the resistance to salt damage can be improved.

The amount of salt included per 100 g of the roots of Example 1 was about 0.062 g. The amount of salt included per 100 g of the roots of Comparative Example 1 was about 0.05 g. The amount of salt included per 100 g of the roots of Example 2 was about 0.49 g. The amount of salt included per 100 g of the roots of Comparative Example 2 was about 0.45 g. The amount of salt is determined by multiplying the amount of sodium included per 100 g of the roots by 2.54.

### (Results of Comparative Test 2)

Comparative Test 2 was performed on the culture soil used in the first embodiment. In Comparative Test 2, Komatsuna (Japanese mustard spinach) was cultivated for one month under four different conditions. Then, using the sample group under each condition as Example 3, Example 4, Comparative Example 3, and Comparative Example 4, the average weight of the edible portions of the cultivated Komatsuna was determined. In this test, the edible portion of Komatsuna refers to portions of a stem and leaves excluding a root.

Example 3 is Komatsuna cultivated by using the culture soil described in the first embodiment and spraying pure water. That is, the culture soil used for the cultivation of Example 3 includes about 0.27 g of SiO₂ particles per 1 L of the soil. Komatsuna was seeded on the culture soil. Immediately after seeding Komatsuna, about 20 mL of pure water per 1 L of the culture soil was sprayed every day except for rainy conditions.

Example 4 is Komatsuna cultivated using the culture soil described in the first embodiment and by spraying a 1% sodium chloride solution. The cultivation conditions of Example 4 are the same as those of Example 3 except for the type of spray water. Thus, the culture soil used for the cultivation of Example 3 includes about 0.27 g of SiO₂ particles per 1 L of the soil. Komatsuna was seeded on the culture soil, and immediately thereafter, about 20 mL of a 1% sodium chloride solution per 1 L of the culture soil was sprayed every day except for rainy conditions.

Comparative Example 3 is Komatsuna cultivated by using the soil described in the first embodiment and by spraying pure water. That is, the soil used in the cultivation of Comparative Example 3 does not include the above-described soil modifier. The cultivation conditions of Comparative Example 3 are the same as those of Example 3 except that the soil does not include a soil modifier. Komatsuna was seeded on this soil, and immediately thereafter, about 20 mL of pure water per 1 L of culture soil was sprayed every day except for rainy conditions.

Comparative Example 4 is Komatsuna cultivated using the soil described in the first embodiment and by spraying a 1% sodium chloride solution. That is, the soil used in the cultivation of Comparative Example 4 does not include the above-described soil modifier. The cultivation conditions of Comparative Example 4 are the same as those of Example 4 except that the soil does not include a soil modifier. Komatsuna was seeded on the soil, and immediately thereafter, about 20 mL of a 1% sodium chloride solution per 1 L of the culture soil was sprayed every day except for rainy conditions.

As shown in FIG. 4, the average weight of the edible portion of Example 3 was about 45.2 g. In contrast, the average weight of the edible portion of Comparative Example 3 was about 26.4 g. From the test results of Example 3 and Comparative Example 3, it has also been found for Komatsuna that the growth of plants can be promoted by including the SiO₂ particles in the soil.

The average weight of the edible portion of Example 4 was about 22.5 g. In contrast, the average weight of the edible portion of Comparative Example 4 was about 17.6 g. From the results of Example 4 and Comparative Example 4, it has been found that the resistance to salt damage can be improved.

In addition, although not illustrated, many insect bites were observed in the leaves of Komatsuna of Comparative Example 3. In contrast, insect bites were hardly observed in the leaves of Komatsuna of Example 3. Therefore, it has been found that insect damage can be suppressed by including the soil modifier in the soil. On the leaves of Komatsuna of Example 4 and Comparative Example 4, insect bites were hardly observed. This is presumed to be because the insect pest avoided the leaves of Komatsuna of Example 4 and Comparative Example 4 because the soil includes a large amount of salt.

In addition, the amount of salt included per 100 g of the edible portion of Example 3 was about 0.055 g. The amount of salt included per 100 g of the edible portion of Comparative Example 3 was about 0.056 g. The amount of salt included per 100 g of the edible portion of Example 4 was about 0.55 g. The amount of salt is determined by multiplying the amount of sodium included per 100 g of the roots by 2.54. In addition, from the ratios of the amount of salt of Comparative Example 2 and Example 2, the amount of salt included per 100 g of the edible portion of Comparative Example 4 can be estimated to be about 0.50 g.

### (Results of Comparative Test 3)

Comparative Test 3 was performed on the soil including the soil modifier of the first embodiment and the soil not including the soil modifier. In Comparative Test 3, the power generation amount of microbial power generation due to the metabolism of microorganisms included in culture soil or soil was measured. Specifically, first, the culture soil of Example 5 and the soil of Comparative Example 5 were charged into a microorganism power generation measuring instrument (microbial fuel cell experiment instrument, part number: MudWatt, KENIS LIMITED). Then, the voltage generated between the electrodes of the microbial power generation measuring instrument was measured two weeks after the charge.

Example 5 is culture soil in which pure water is sprayed on soil including the soil modifier described in the first embodiment. That is, the sample of Example 5 includes about 0.27 g of SiO₂ particles per 1 L of soil.

Comparative Example 5 is soil obtained by spraying pure water to the soil described in the first embodiment. That is, the soil of Comparative Example 5 does not include the soil modifier. The conditions of Comparative Example 5 are the same as those of Example 5 except that the soil does not include a soil modifier.

As shown in FIG. 5, the microbial power generation voltage in the culture soil of Example 5 was 0.725 V. In contrast, the microbial power generation voltage in the culture soil of Comparative Example 5 was 0.475 V. From this test result, it has been found that the growth of microorganisms living in the soil was promoted in about two weeks after the soil modifier of the first embodiment was mixed in the soil. In addition, it has been found that in about 2 weeks after the soil modifier of the first embodiment is mixed in the soil, culture soil having a voltage of 0.7 V or more by microbial power generation is obtained.

### (Method for Producing Soil Modifier)

Then, a first embodiment of a method for producing a soil modifier will be described. In the first embodiment, the soil modifier is produced using SiO₂ particles produced in the process of producing an electronic component.

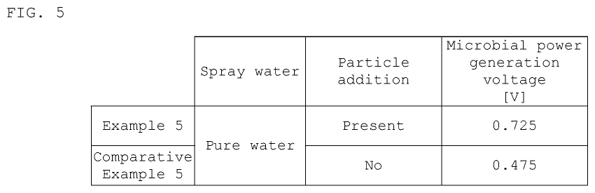

As shown in FIG. 6, the method for producing a soil modifier includes a laminate preparation step S11, a solvent charging step S12, a catalyst charging step S13, an object charging step S14, a polymer charging step S15, and a metal alkoxide charging step S16. In addition, the method for producing a soil modifier further includes a film forming step S17, a base body retrieving step S18, a recovery step S19, a drying step S20, and a firing step S21.

First, in forming the base body 10, a laminate that is a cuboid base body 10 is prepared in the laminate preparation step S11. For example, first, a plurality of ceramic sheets to serve as the base body 10 are provided. The sheet has a thin plate shape. A conductive paste serving as an electrode and a wiring is laminated on the sheet. On the stacked paste, the ceramic sheet to serve as the base body 10 is laminated. In this manner, the ceramic sheet and the conductive paste are laminated. Then, an unfired laminate is formed by cutting into a predetermined size. Thereafter, the unfired laminate is subjected to firing at a high temperature to provide a laminate.

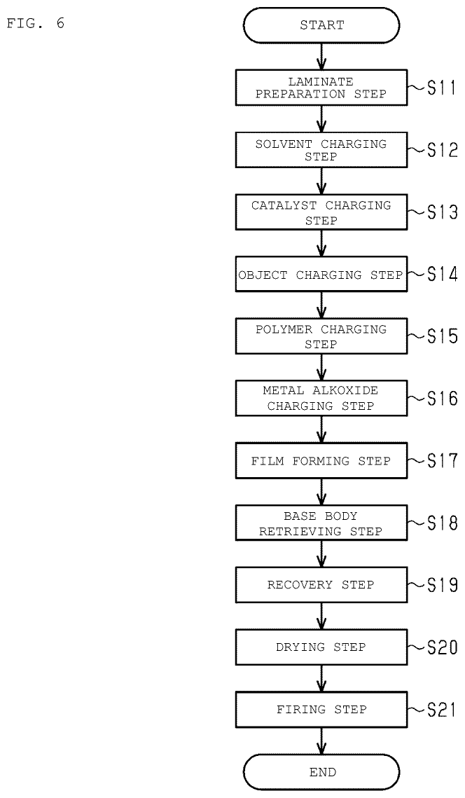

Then, as shown in FIG. 6, the solvent charging step S12 is performed. As shown in FIG. 7, 2-propanol is put as a solvent 12 into a reaction container 11 in the solvent charging step S12.

Then, as shown in FIG. 6, the catalyst charging step S13 is performed. As shown in FIG. 8, first, the solvent 12 in the reaction container 11 is started to be stirred in the catalyst charging step S13. Then, as an aqueous solution 13 including a catalyst, ammonia water is charged into the reaction container 11. The catalyst in the first embodiment is a hydroxide ion, and functions as a catalyst that promotes hydrolysis of a metal alkoxide 15 described later.

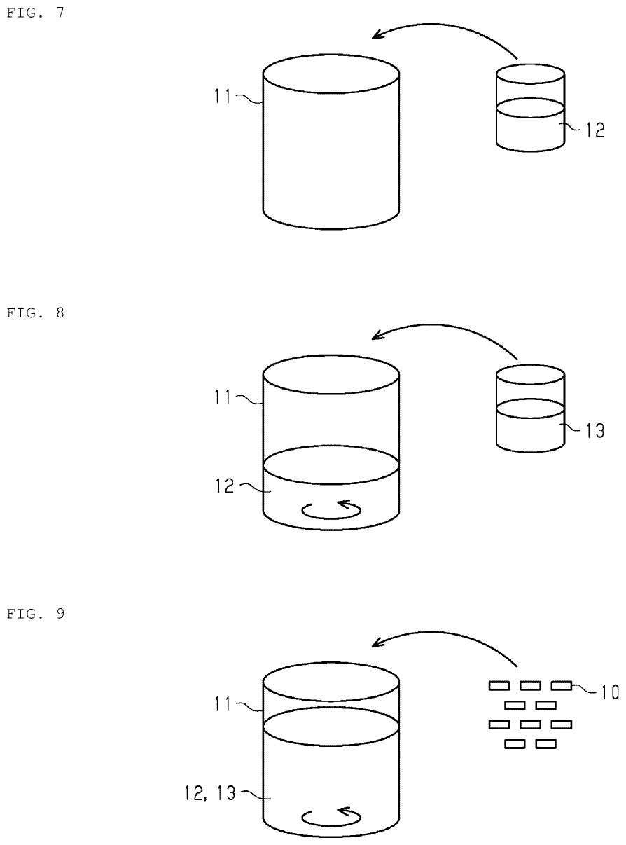

Then, as shown in FIG. 6, the object charging step S14 is performed. As shown in FIG. 9, in the object charging step S14, a plurality of base bodies 10 formed previously in the above-described laminate preparation step S11 are charged as objects into the reaction container 11.

Then, as shown in FIG. 6, the polymer charging step S15 is performed. As shown in FIG. 10, a polyvinylpyrrolidone is charged as a polymer 14 into the reaction container 11 in the polymer charging step S15. Thus, the polymer 14 charged into the reaction container 11 adsorbs to the outer surface of the base body 10.

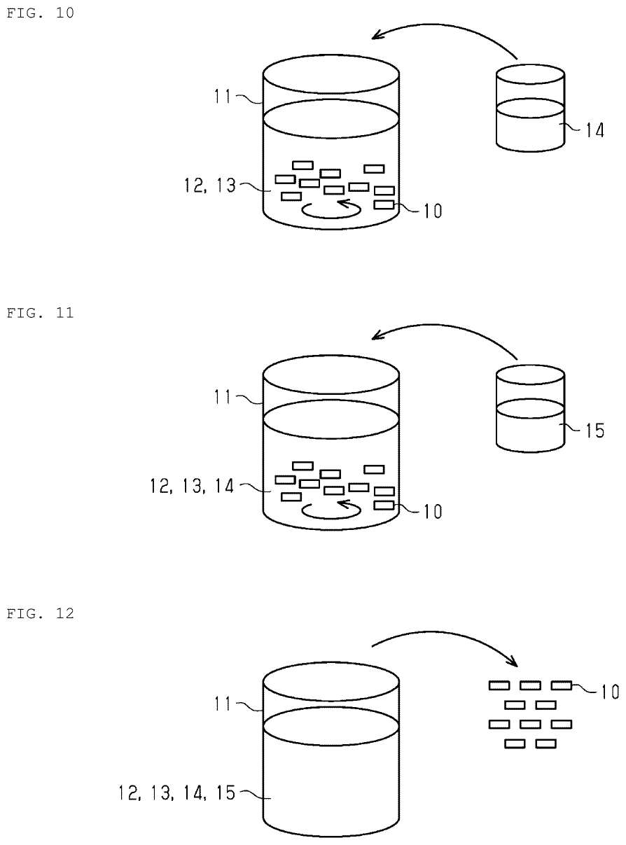

Then, as shown in FIG. 6, the metal alkoxide charging step S16 is performed. As shown in FIG. 11, a liquid tetraethyl orthosilicate is charged as the metal alkoxide 15 into the reaction container 11 in the metal alkoxide charging step S16. Tetraethyl orthosilicate may be referred to as tetraethoxysilane.

Then, as shown in FIG. 6, the film forming step S17 is performed. In the film forming step S17, the stirring of the solvent 12, started in the solvent charging step S12 described above, is continued for a predetermined period of time, after the metal alkoxide 15 is charged into the reaction container 11 in the metal alkoxide charging step S16. Thus, the metal alkoxide 15 is hydrolyzed with the hydroxide ion as a catalyst. When the metal alkoxide 15 is hydrolyzed, the hydrolyzed metal alkoxide 15 adheres to the surfaces of the base bodies 10. Then, the metal alkoxides 15 adhering to the surfaces of the base bodies 10 are dehydrated and condensed to form the glass film. Thus, in the film forming step S17, the sol-like glass film is formed by a liquid phase reaction in the reaction container 11. In addition, in the solution, the dehydration condensation reaction between the metal alkoxides 15 proceeds. As a result, sol-like SiO₂ particles are generated as by-products.

Then, as shown in FIG. 6, a base body retrieving step S18 is performed. As shown in FIG. 12, in the base body retrieving step S18, the base body 10 is retrieved from the reaction container 11. Drying and firing the base body 10 provides an electronic component in which a glass film is formed on the outer surface of the base body 10.

Then, as shown in FIG. 6, a recovery step S19 is performed. In the recovery step S19, SiO₂ particles present in the solution in the reaction container 11 are recovered. Specifically, evaporating the solvent 12 in the reaction container 11 causes SiO₂ particles remaining in the reaction container 11 to be recovered. As described above, this solution includes sol-like SiO₂ particles. Tetraethyl orthosilicate and polyvinylpyrrolidone adhere to the outer surface of the recovered SiO₂ particles.

Then, as shown in FIG. 6, the drying step S20 is performed. In the drying step S20, the sol-like SiO₂ particles recovered in the recovery step S19 are dried. As a result, most of liquid components such as 2-propanol and water are removed from the recovered sol-like SiO₂ particles. Through this drying step S20, the base particles 100 having a particle size of 100 nm or more are generated as SiO₂ particles. The central particle size of base particles 100 is 120 nm to 800 nm in the particle size distribution of base particles 100. The particle size of the generated base particles 100 can be controlled, for example, by adjusting the time of the film forming step S17.

Then, as shown in FIG. 6, the firing step S21 is performed. In the firing step S21, the SiO₂ particles subjected to the drying step S20 are fired at a temperature of 300° C. to 450° C. for a time of 5 minutes to 40 minutes. Specifically, firing is performed at a temperature of 400° C. for 30 minutes. As a result, the gel-like SiO₂ particles included in the solution are cured by vaporization of the moisture and the polymer 14. Through this firing step S21, fine particles 200 having a particle size of less than 100 nm are generated as SiO₂ particles. The central particle size of the generated fine particles 200 is 10 nm to 100 nm in the particle size distribution of the fine particles 200. In addition, among the generated fine particles 200, those in contact with the base particles 100 are sintered together with the base particles 100 during the firing step S21. Therefore, the fine particles 200 adhere to the surface of the base particles 100. The particle size of the SiO₂ fine particles 200 to be generated can be controlled by adjusting the firing temperature and time in the firing step S21. In this manner, the soil modifier including the SiO₂ base particles 100 having a central particle size of 120 nm to 800 nm and the fine particles 200 having a central particle size of 10 nm or more and less than 100 nm is produced.

### Effects of First Embodiment

(1-1) In the first embodiment, the soil modifier and the culture soil include SiO₂ particles having a central particle size of 120 nm to 800 nm in particle size distribution. From the results of Comparative Test 1 and Comparative Test 2, the soil modifier is included in the soil, thereby allowing the growth of the plants to be promoted regardless of the type of plant, that is, the capacity of the plant to absorb silicate. Although the reason why the growth of plants can be promoted is not clear, it is presumed that the inclusion of SiO₂ particles activates useful microorganisms in the soil or causes excessive salt in the soil to be adsorbed to SiO₂ particles.

(1-2) From the results of Comparative Test 1, the weight ratio of roots to leaves in Example 1 was about 1.8 times the weight ratio in Comparative Example 1. Therefore, inclusion of the soil modifier in the soil can particularly promote the growth of roots.

(1-3) From the results of Comparative Test 2, inclusion of the soil modifier in the soil provides an effect of suppressing insect damage.

(1-4) From the results of Comparative Test 1 and Comparative Test 2, inclusion of the soil modifier in the soil allows salt damage due to high salt content to be prevented. In addition, the weight ratio of roots to leaves in Example 2 was about twice the weight ratio in Comparative Example 2. Therefore, in particular, it is possible to suppress salt damage in a portion of the plant directly in contact with the soil. In addition, plants can grow in the soil having high salt content, and thus cultivating edible plants in the soil having high salt content allows salinity to be imparted to the plants. This increases the possibility of cultivating edible plants using sea water and brackish water as spray water.

(1-5) In the first embodiment, the coefficient of variation, which is the ratio of the standard deviation of the particle size of the particles to the average value of the particle size of the particles, is 0.30 or less. When the particle size is uniform, the reproducibility of the effect described in (1-1) is easily obtained.

(1-6) In the first embodiment, the soil modifier includes SiO₂ particles in a weight ratio of 99% or more. The effect described in (1-1) is presumed to be mainly caused by SiO₂, and thus the effect described in (1-1) is more easily exhibited as the content of SiO₂ increases.

(1-7) In the first embodiment, the soil modifier further includes one or more elements or molecules selected from Na, Cl, P₂O₅, and SO₃. Na, Cl, P, and S are known as nutrients essential for plant growth. Therefore, it is not necessary to separately mix other fertilizers with the soil.

(1-8) In the first embodiment, the culture soil includes SiO₂ particles in an amount of 0.2 g to 1.2 g based on 1 liter of the soil. Inclusion of SiO₂ at the above ratio easily provides the effect of promoting the plant growth.

(1-9) In the first embodiment, the voltage of the culture soil due to microbial power generation is 0.7 V or more. As described above, the culture soil in which the activity of microorganisms is active is suitable for cultivation of plants.

(1-10) In the first embodiment, the soil modifier can be produced using a solution including particles of SiO₂ which is an industrial by-product. As a result, it is possible to save time and effort for processing such as discarding the solution including the SiO₂ particles. In addition, energy consumed for the processing can be reduced, which is thus favorable for the environment.

(1-11) In the first embodiment, the ratio of the surface area per unit weight of the SiO₂ particles is 15 m²/g to 200 m²/g. In addition, the SiO₂ particles include carbon in a weight ratio of 1.5% to 5.0%. Further, the ratio of the volume of the voids 103 to the volume of the SiO₂ particles is 0.2% to 6.0%. As the results of the respective comparative tests described above, the soil modifier including SiO₂ particles having these characteristics can promote the plant growth.

(1-12) In the first embodiment, the fine particles 200 adhere to the outer surface of the base particles 100. The presence of these fine particles 200 increases the contact area of all of SiO₂ particles in the soil. Therefore, the effect of promoting the plant growth by SiO₂ particles is easily obtained.

### Second Embodiment

Hereinafter, a second embodiment of a soil modifier, a culture soil, and a method for producing a soil modifier will be described.

### (Soil Modifier)

The soil modifier of the second embodiment includes base particles 100 as SiO₂ particles. As in the first embodiment, the “base particles” are SiO₂ particles having a particle size of 100 nm or more among the SiO₂ particles. The central particle size of base particles 100 is 120 nm to 800 nm in the particle size distribution of base particles 100. In contrast, the soil modifier of the second embodiment does not include SiO₂ particles having a particle size of less than 100 nm, or if the soil modifier includes SiO₂ particles, the amount of SiO₂ particles is significantly small compared to the amount of the base particles 100. For example, in the soil modifier of the second embodiment, the number of particles of SiO₂ having a particle size of less than 100 nm is 1/100 or less of the number of particles of the base particles 100.

In the soil modifier, the specific surface area of the SiO₂ particles is 15 m²/g to 200 m²/g. For example, in the second embodiment, the specific surface area of the SiO₂ particles is 18.3 m²/g.

In the soil modifier, the SiO₂ particles include carbon in a weight ratio of 1.5% to 5.0%. For example, in the first embodiment, the SiO₂ particles include carbon in a weight ratio of 4.4%.

As shown in FIG. 3, the base particles 100 include a core portion 101 and an outer layer 102.

The core portion 101 has a substantially spherical shape including the center of gravity of SiO₂ particles. The core portion 101 has a void 103 therein. The porosity of the single particle is 0.2% to 6.0%. More specifically, in the second embodiment, the porosity of the single particle is 2.5% to 6.0%. For example, the porosity of a single particle is 5.7%.

The outer layer 102 is a portion that covers the core portion 101 from the outside and includes the outer surface of the base particle 100. The outer layer 102 is provided on the surface side including the outer surface. The concentration of polyvinylpyrrolidone in the outer layer 102 is higher than the concentration of polyvinylpyrrolidone in a portion excluding the outer layer 102 of the SiO₂ particles, that is, in the core portion 101. In addition, for example, when SiO₂ particles are imaged by a field emission transmission electron microscope (FE-TEM), an interface in the SiO₂ particle is observed substantially clearly between the outer layer 102 and a portion excluding the outer layer 102.

The ratio of the thickness T of the outer layer 102 to the particle size D of the base particle 100 is 2% or more. For example, the particle size D of the base particles 100 is about 260 nm. The thickness T of the outer layer 102 is about 15 nm. Therefore, the ratio of the thickness T of the outer layer 102 to the particle size D of SiO₂ particles is about 5.2%.

The thickness T of the outer layer 102 is defined as follows. First, the base particles 100 are imaged using FE-TEM or the like. In the image, a dimension of the outer layer 102 in a direction perpendicular to the outer surface at any point on the outer surface of the base particle 100 is defined as a thickness T of the outer layer 102 at the point. More specifically, the “direction perpendicular to the outer surface of the base particle at any point on the outer surface of the base particle” is a direction perpendicular to a tangent line when the tangent line of the base particle 100 having the any point as a contact point is drawn. The “thickness of the outer layer” is a distance from the any point to the interface in the perpendicular direction.

### (Method for Producing Soil Modifier)

In the method for producing the soil modifier of the second embodiment, the step from the laminate preparation step S11 to the drying step S20 is the same as in the first embodiment. The soil modifier of the second embodiment causes SiO₂ particles to be recovered after the drying step S20. As a result, the soil modifier is produced. That is, the soil modifier of the second embodiment is SiO₂ particles after the drying step S20 and before the firing step S21 in the production method of the first embodiment.

### Effects of Second Embodiment

The second embodiment, in addition to the effects (1-1) to (1-11) of the first embodiment, exhibits the following effects.

(2-1) In the second embodiment, the base particle 100 has the outer layer 102 covering the core portion 101. The main component of the outer layer 102 is polyvinylpyrrolidone. In addition, the ratio of the thickness T of the outer layer 102 to the particle size D of the base particle 100 is 2% or more. Polyvinylpyrrolidone has various properties such as high hygroscopicity and thickening. Therefore, inclusion of the outer layer 102 in the base particle 100 can exhibit an effect suitable for plant growth promotion, such as prevention of soil dryness and sustained release of active ingredients.

### Modification Examples

The first embodiment, the second embodiment, and modifications below can be implemented in combination within a range that is not technically contradictory.

The coefficient of variation of the particle size of SiO₂ particles included in the soil modifier may be more than 0.30. If the particle size varies, the effect described in (1-1) can be obtained as long as the central particle size is 120 nm to 800 nm.

The particles of SiO₂ included in the soil modifier may have a weight ratio of less than 99%. If the relative amount of SiO₂ particles included in the soil modifier is small, the effect described in (1-1) can be obtained as long as the absolute amount of SiO₂ particles is large.

The soil modifier may not include any of Na, Cl, P₂O₅, and SO₃. If these elements or molecules are not included, the effect described in (1-1) can be obtained as long as particles of SiO₂ are included. In addition, the content ratio of each of Na, Cl, P₂O₅, and SO₃ included in the soil modifier is not limited to the example of the above embodiment.

The soil included in the culture soil is not limited to the example of the above embodiment as long as it is a soil capable of crop cultivation such as sandy loam, loam, or clay loam. Appropriate modification is possible according to the crop to be cultivated.

The plants, growth of which can be promoted by the soil modifier and the culture soil, are not limited to crops. For example, it is presumed that the effect described in (1-1) can be obtained by using the soil modifier and the culture soil in the flower cultivation.

The SiO₂ particles included in the culture soil may be more than 1.5 g based on 1 liter of soil. There is no direct excessive damage of silicon to plants. Therefore, if the amount of SiO₂ included in the soil is large, there is no direct adverse effect on plants.

The voltage due to microbial power generation may be less than 0.7 V. When the culture soil includes SiO₂ particles having a central particle size of 120 nm to 800 nm, the effect described in (1-1) can be obtained.

The culture soil may include a microbial material. From the results of Comparative Test 3, it is presumed that the culture soil promotes the growth of microorganisms that inhabit the soil. Therefore, the effect of the microbial material can be improved.

The soil modifier may be produced in the process of forming a glass film on an object, and may not be produced in the process of producing an electronic component. That is, the object to be charged into the reaction container 11 in the object charging step S14 may not be the base body of the electronic component.

The solvent 12 charged in the solvent charging step S12 is not limited to the example of the embodiment mentioned above, and may be any liquid that can disperse the metal alkoxide 15 appropriately.

The solvent charging step S12 may be performed after the catalyst charging step S13 or the object charging step S14. The solvent charging step S12 may be performed before at least any one of the metal alkoxide charging step S16 and the catalyst charging step S13. In addition, the solvent charging step S12 may be omitted. In this case, for example, when the amount of water contained in the aqueous solution 13 containing the catalyst is appropriately large, the metal alkoxide 15 reacts in the liquid phase. In addition, the aqueous solution 13 containing the catalyst may be charged in a state of being mixed with an organic solvent as the solvent 12.

Although it has been described that the catalyst is charged as the aqueous solution 13 containing the catalyst, a solid compound containing the catalyst and water may be separately charged into the reaction container 11. In this case, it can be considered that the catalyst is charged into the reaction container 11 because the catalyst is generated in the reaction container 11. In addition, for example, a solid compound containing the catalyst may be charged into the reaction container 11, and moisture in the air may be used as water required for the hydrolysis.

The object charging step S14 may be performed before the catalyst charging step S13. In addition, when the object charging step S14 is performed before the catalyst charging step S13, the metal alkoxide charging step S16 may be performed before the catalyst charging step S13 or the object charging step S14. The object charging step S14 may be performed before at least any one of the metal alkoxide charging step S16 and the catalyst charging step S13.

In the metal alkoxide charging step S16, the metal alkoxide 15 may be generated in the reaction container 11 without being charged into the reaction container 11 after the metal alkoxide 15 is generated outside the reaction container 11. For example, the metal alkoxide 15 is produced by a reaction between a metal salt and an alcohol. Thus, the metal alkoxide 15 can be considered as being charged in the reaction container 11, also based on the fact that the metal salt that is a metal alkoxide precursor and the alcohol are charged into the reaction container 11 and then allowed to react with each other to produce the metal alkoxide 15.

The metal alkoxide 15 is not limited to any tetraethyl orthosilicate. As for the alkoxy group of the metal alkoxide 15, a methoxy group, a propoxy group, or the like may be used, or a functional group such as a long-chain alkyl group or an epoxy group may be modified like a coupling agent. Furthermore, the coordination number with respect to the metal contained in the metal alkoxide 15 is not limited to being four-coordination, and may be three-coordination or two-coordination.

The base body retrieving step S18 may be omitted. That is, the recovery step S19 may be performed in a state where the base body 10 exists in the reaction container 11.

In the firing step S21, the temperature at which the sol-like or gel-like particles are fired may be less than 300 degrees or more than 450 degrees. In addition, the time for firing may be less than 5 minutes or more than 40 minutes. For example, if the temperature is more than 450 degrees, it is sufficient that particles of SiO₂ having a central particle size of 120 nm to 800 nm can be produced by firing in a time of less than 5 minutes.

In the recovery step S19, the method for recovering SiO₂ particles is not limited to the example of the above embodiment. For example, the solvent 12 may be evaporated by drying under reduced pressure.

The particle size of the SiO₂ base particles 100 generated in the drying step S20 and the firing step S21 may be controlled by the concentration and the like of the material in each step.

As exemplified in the first embodiment and the second embodiment, the soil modifier does not necessarily include the fine particles 200, and may be composed of only the base particles 100. In addition, when the fine particles 200 are included, the fine particles 200 may not adhere to the base particles 100.

The soil modifier may include both the SiO₂ particles in the first embodiment and the SiO₂ particles in the second embodiment. In other words, both the SiO₂ particles after the firing step S21 and the SiO₂ particles after the drying step S20 in which the firing step S21 is not performed may be included.

The particles of SiO₂ may have a surface area ratio per unit weight of less than 15 m²/g or more than 200 m²/g. In addition, the ratio of carbon included in the SiO₂ particles may be less than 1.5% or more than 5.0% by weight. Also in these cases, the effect described in (1-1) can be obtained.

The ratio of the voids 103 included in the SiO₂ particles may be less than 0.2% or more than 6.0%. In addition, the core portion 101 may not have the void 103 therein. The ratio of the thickness T of the outer layer 102 to the particle size D of SiO₂ particles may be less than 2%. Also in these cases, the effect described in (1-1) can be obtained.

In the second embodiment, in the SiO₂ particles, the concentration of polyvinylpyrrolidone in the outer layer 102 may be equal to or less than the concentration of polyvinylpyrrolidone in the core portion 101. In addition, the ratio of the thickness T of the outer layer 102 to the particle size D of SiO₂ particles may be less than 2%. Also in these cases, the effect described in (1-1) can be obtained.

In the SiO₂ particles in the first embodiment, the ratio of the thickness T of the outer layer 102 to the particle size D of the SiO₂ particles is less than 2%, or the particles do not include the outer layer 102. That is, the particles of SiO₂ as the soil modifier may have no clear boundary between the core portion 101 and the outer layer 102.

### DESCRIPTION OF REFERENCE SYMBOLS

100: Base particles
101: Core portion
102: Outer layer
103: Void
200: Fine particles
S13: Catalyst charging step
S14: Object charging step
S15: Polymer charging step
S16: Metal alkoxide charging step
S17: Film forming step
S19: Recovery step
S20: Drying step
S21: Firing step

1. A soil modifier comprising:
SiO₂ particles, wherein
a central particle size of the SiO₂ particles having a particle size of 100 nm or more is 120 nm to 800 nm in a particle size distribution of the SiO₂ particles.

2. The soil modifier according to claim 1, wherein a coefficient of variation that is a ratio of a standard deviation of particle sizes of the SiO₂ particles to an average value of particle sizes of the SiO₂ particles is 0.30 or less.

3. The soil modifier according to claim 1, wherein the soil modifier includes the SiO₂ particles in a weight ratio of 99% or more.

4. The soil modifier according to claim 1, further comprising one or more selected from Na, Cl, P₂O₅, and SO₃.

5. The soil modifier according to claim 4, wherein the soil modifier includes the Na in a weight ratio of 6 ppm, Cl in a weight ratio of 0.02%, P₂O₅ in a weight ratio of 0.01%, and SO₃ in a weight ratio of 0.04%.

6. The soil modifier according to claim 1, wherein
the SiO₂ particles having the particle size of 100 nm or more are base particles,
the soil modifier further includes fine particles of SiO₂ having a particle size of less than 100 nm, and
a central particle size of the fine particles is 10 nm or more and less than 100 nm in a particle size distribution of the fine particles, and
a plurality of the fine particles adhere to an outer surface of the base particles.

7. The soil modifier according to claim 1, wherein a ratio of a surface area per unit weight of the SiO₂ particles is 15 m²/g to 200 m²/g.

8. The soil modifier according to claim 1, wherein the SiO₂ particles include carbon in a weight ratio of 1.5% to 5.0%.

9. The soil modifier according to claim 1, wherein
the SiO₂ particles have voids therein, and
when one particle of the SiO₂ particles is viewed in a section,
a ratio of an area of a region occupied by the voids to a sectional area of the one particle is 0.2% to 6.0%.

10. The soil modifier according to claim 1, wherein
the SiO₂ particles having the particle size of 100 nm or more include a core portion and an outer layer covering the core portion and defining an outer surface of the SiO₂ particles, and
a concentration of polyvinylpyrrolidone in the outer layer is higher than a concentration of polyvinylpyrrolidone in the core portion.

11. The soil modifier according to claim 10, wherein
when a dimension of the outer layer in a direction perpendicular to the outer surface at any point of the outer surface is defined as a thickness of the outer layer at the point,
a ratio of a thickness of the outer layer to a particle size of the SiO₂ particles is 2% or more.

12. A culture soil comprising:
a soil; and
the soil modifier according to claim 1.

13. The culture soil according to claim 12, wherein the base SiO₂ particles are in an amount of 0.2 g to 1.5 g based on 1 liter of the soil.

14. The culture soil according to claim 12, wherein the culture soil has a voltage by microbial power generation of 0.7 V or more.

15. A soil modifier comprising:
base SiO₂ particles having a particle size of 100 nm or more; and
a plurality of fine SiO₂ particles having a particle size of less than 100 nm, wherein the plurality of the fine SiO₂ particles are adhered to an outer surface of the base SiO₂ particles.

16. The soil modifier according to claim 15, wherein a coefficient of variation that is a ratio of a standard deviation of particle sizes of the base SiO₂ particles to an average value of particle sizes of the base SiO₂ particles is 0.30 or less.

17. The soil modifier according to claim 15, further comprising one or more selected from Na, Cl, P₂O₅, and SO₃.

18. The soil modifier according to claim 15, wherein
the base SiO₂ particles have voids therein, and
when one particle of the base SiO₂ particles is viewed in a section, a ratio of an area of a region occupied by the voids to a sectional area of the one particle is 0.2% to 6.0%.

19. A method for producing a soil modifier, the method comprising:
charging an object to be coated with a glass film into a reaction container;
charging a metal alkoxide or a metal alkoxide precursor into the reaction container;
charging a catalyst for accelerating hydrolysis of the metal alkoxide into the reaction container;
forming a glass film on a surface of the object by hydrolyzing, and dehydrating and condensing the metal alkoxide;
recovering SiO₂ particles included in a solution in the reaction container after the forming of the glass film; and
drying the SiO₂ particles, wherein the central particle size of the SiO₂ particles having a particle size of 100 nm or more is 120 nm to 800 nm in a particle size distribution of the SiO₂ particles.

20. The method for producing a soil modifier according to claim 19, wherein the SiO₂ particles having the particle size of 100 nm or more are base particles, and the method further comprises:
firing the dried base particles after the drying step;
after the firing step, including SiO₂ fine particles having a particle size of less than 100 nm in addition to the base particles, wherein a central particle size of the SiO₂ fine particles is 10 nm or more and less than 100 nm in a particle size distribution of the SiO₂ fine particles.
